(19) United States
(12) Patent Application Publication
(10) Pub. No.: US 2014/0376667 A1
(43) Pub. Date: Dec. 25, 2014

(54) Frequency-Domain Carrier Blanking For Multi-Carrier Systems

(71) Applicants: Jianqiang Zeng, Austin, TX (US); Steven M. Bosze, Cedar Park, TX (US); Raja V. Tamma, Leander, TX (US); Kevin B. Traylor, Austin, TX (US)

(72) Inventors: Jianqiang Zeng, Austin, TX (US); Steven M. Bosze, Cedar Park, TX (US); Raja V. Tamma, Leander, TX (US); Kevin B. Traylor, Austin, TX (US)

(21) Appl. No.: 13/924,940

(22) Filed: Jun. 24, 2013

(51) Int. Cl. H04L 27/26

(52) U.S. Cl. CPC H04L 27/2657
USPC 375/340

(57) ABSTRACT

Methods and systems are disclosed for frequency-domain carrier blanking in multi-carrier communication systems. When excessive energy is detected in one or more subcarriers within a received symbol for multi-carrier communications, those subcarriers are blanked for subsequent demodulation in order to avoid corruption of the demodulated data. A conversion from time-domain digital samples to frequency-domain values using an FFT (Fast Fourier Transform) and a threshold detector are utilized to detect corrupted subcarriers. Further, this frequency-domain carrier blanking can be implemented dynamically on a symbol-by-symbol basis to further improve demodulation performance by reducing decoding errors. The disclosed embodiments are particularly useful for improving demodulation performance in power line communication (PLC) systems.

### TECHNICAL FIELD

This technical field relates to reducing errors with respect to demodulation and decoding of received symbols in multi-carrier communication environments.

### BACKGROUND

In multi-carrier systems, data is transmitted on multiple subcarriers and then collected at a receiver for the multi-carrier system. OFDM (orthogonal frequency division multiplexing) symbols are used by some multi-carrier systems where transmitted data is encoded on a number of closely spaced orthogonal subcarriers. Further, some multi-carrier systems utilize standard transmission protocols to facilitate the detection and synchronization of received symbols. Once frame detection and synchronization has occurred within a receiver, the symbols are demodulated and further processed to obtain the transmitted data. This recovered data can then be utilized by higher processes within the receiver and/or within other processing devices connected to the receiver. Power line communication (PLC) systems, for example, utilize OFDM symbols for multi-carrier communications across power lines between transmitters and receivers.

In a multi-carrier communication system, subcarriers within a received symbol can be destroyed in the presence of strong narrow band interference or impulsive noise. For example, if a strong tone is always present in the transmission medium, subcarriers occupying frequency locations affected by this strong tone can be corrupted leading to false demodulated data within the receiver. Furthermore, a transmitted frame may contain several OFDM symbols, and as such, a non-persistent impulse noise that corrupts subcarriers within a single symbol or within a sequence of symbols in a transmitted frame can still lead to false demodulated data within the receiver. The destroyed subcarriers and related data loss can negatively impact communications, for example, by increasing the BER (Bit Error Rate). A higher BER can cause receivers to fail or have degraded throughput. To correct such data errors, typical receiver implementations rely upon error correction mechanisms, such as interleaving and forward error correction (FEC) with convolutional coding. Error correction mechanisms, however, can become less effective in counter-acting the effects of channel noise if subcarrier destruction becomes significant. Further, certain multi-carrier signal environments, such as power line communication (PLC) channels, present particularly harsh environments for accurate demodulation and decoding of received symbols due to the common occurrence of interfering tones and impulse noise.

### DESCRIPTION OF THE DRAWINGS

It is noted that the appended figures illustrate only example embodiments and are, therefore, not to be considered as limiting the scope of the present invention. Elements in the figures are illustrated for simplicity and clarity and have not necessarily been drawn to scale

FIG. 1 is a block diagram of an example embodiment of a receiver system utilizing frequency-domain carrier blanking to reduce errors in symbol demodulation for multi-carrier signals.

FIG. 2 is a signal diagram of an example embodiment for a multi-carrier signal including a preamble and data symbols as utilized in some PLC systems.

FIG. 3 is a block diagram of an example embodiment of a frequency-domain carrier blanking block for processing received multi-carrier symbols.

FIG. 4 is a process flow diagram of an example embodiment for processing received multi-carrier symbols utilizing frequency-domain carrier blanking

FIG. 5 is an example embodiment for representative subcarrier diagrams for frequency-domain carrier blanking to reduce errors in burst demodulation for multi-carrier signals.

FIG. 6 is an example embodiment for a representative diagram comparing results for using and not using frequency-domain carrier blanking in the presence of noise within the communication channel.

FIG. 7 is an example embodiment for a representative diagram of multi-carrier symbols affected by tone interferers and impulse noise degrading some subcarriers.

FIG. 8 is an example embodiment for representative subcarrier diagrams for channel noise degrading subcarriers within a received symbol.

### DETAILED DESCRIPTION

Methods and systems are disclosed for frequency-domain carrier blanking in multi-carrier communication systems. When excessive energy is detected in one or more subcarriers within a received symbol for multi-carrier communications, those subcarriers are blanked for subsequent demodulation in order to avoid corruption of the demodulated data. A conversion from time-domain digital samples to frequency-domain values using an FFT (Fast Fourier Transform) and a threshold detector are utilized to detect corrupted subcarriers. Further, this frequency-domain carrier blanking can be implemented dynamically on a symbol-by-symbol basis to further improve demodulation performance by reducing decoding errors. The disclosed embodiments are particularly useful for improving demodulation performance in power line communication (PLC) systems. Different features and variations can be implemented, as desired, and related or modified systems and methods can be utilized, as well.

As described herein, the disclosed embodiments effectively remove the energy associated with subcarriers identified as severely corrupted within a received symbol. For example, a subcarrier within a symbol having a strong energy level that exceeds threshold levels (e.g., predefined threshold level) can be blanked prior to demodulation of the symbol. For the embodiments disclosed herein, an FFT can be used to generate frequency components from digital samples associated with received symbols, and the blanking has the effect of forcing the constellation values for the real (I) and complex (Q) outputs of the FFT to zero values for subcarriers identified as being corrupted. Further, the frequency-domain carrier blanking can be applied on a symbol-by-symbol basis to address channel noise that may be transient. Advantageously, demodulation performance of a multi-carrier receiver is improved through the use of the disclosed frequency-domain carrier blanking techniques. For example, the blanking of corrupted subcarriers improves error correction mechanisms applied by a receiver and thereby improves BER (bit error rate) performance for the communication system. For example, FEC (forward error correction) mechanisms are rendered more effective by blanking corrupted subcarriers as well as by applying these carrier blanking techniques dynamically on a symbol-by-symbol basis within a multi-symbol transmission.

It is noted that the functional blocks described herein can be implemented using hardware, software, or a combination of hardware and software, as desired. In addition, one or more processors running software and/or firmware can also be used, as desired, to implement the disclosed embodiments. It is further understood that one or more of the operations, tasks, functions, or methodologies described herein may be implemented, for example, as software or firmware and/or other program instructions that are embodied in one or more non-transitory tangible computer readable mediums (e.g., memory) and that are executed by one or more controllers, microcontrollers, microprocessors, hardware accelerators, and/or other processors to perform the operations and functions described herein.

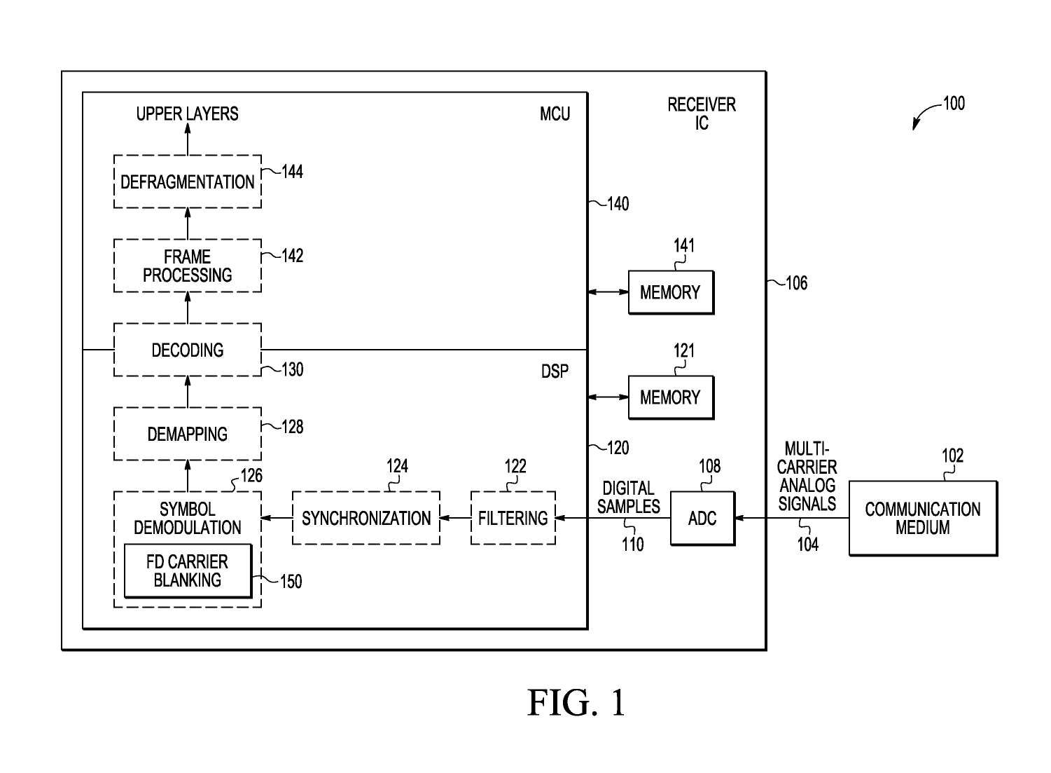

FIG. 1 is a block diagram of an example embodiment 100 of a receiver system including frequency-domain (FD) carrier blanking block 150. For the embodiment 100 depicted, a receiver integrated circuit (IC) 106 is configured to receive multi-carrier analog signals 104 from a communication medium 102. The receiver IC 106 includes analog-to-digital converter (ADC) circuitry 108, digital signal processor (DSP) 120, and microcontroller unit (MCU) 140. One or more memories can also be included within receiver IC 106 and be coupled to DSP 120 and MCU 140, such as for example memory 141 and a memory 121. The DSP 120 includes filtering block 122, synchronization block 124, symbol demodulation block 126, demapping block 128, and decoding block 130. The decoding block 130 also transitions into the MCU 140, which also includes frame processing block 142, and defragmentation block 144. The synchronization block 124 includes frequency-domain carrier blanking block 150, which is described further below. It is noted that the receiver system depicted can also be implemented as a transceiver, if desired, such that the system also includes a transmitter and related operational blocks that allow the system to transmit multi-carrier signals through the communication medium 102. Other variations could also be implemented.

In operation, the received multi-carrier analog signals 104 are filtered by filter block 122 and then digitized by the ADC circuitry 108 to produce digital samples 110 associated with symbols within the received analog signals 104. The ADC circuitry 108 can be configured to generate only real (I) or both real (I) and imaginary (Q) components for each digital sample. The digital samples 110 are filtered by filter block 122 and provided to synchronization block 124. The frequency-domain carrier blanking block 150 within the demodulation block 126 operates to blank a subcarrier within received symbols during demodulation when the subcarrier is identified as corrupted, such as for example, when its energy level exceeds a threshold energy level, as described in more detail herein. After application of carrier blanking by block 150, the demodulation block 126 completes demodulation of the received symbols. The output data from demodulation block 128 is then demapped by demapping block 128 and decoded by decoding block 130. The resulting decoded data is provided to frame processing block 142. After the frames are processed, they are defragmented by defragmentation block 144. The resulting data can then be used and/or further processed by upper layer blocks, such as application layer blocks. Further, the receiver IC 106 can provide outputs to external blocks or devices for use or further processing, if desired.

It is noted that the communication medium 102 can be a wired medium, such as for example, a power line through which signals are communicated. The communication medium could also be a wireless medium, if desired. It also is noted that the multi-carrier analog signals 104 can be, for example, OFDM (orthogonal frequency division multiplexing) signals transmitted through power line channels according to standards for PLC (power line communication) transmissions, such as the G3-PLC standard for PLC systems (G3-PLC). Other multi-carrier signals could also be utilized if desired. Further, it is noted that the receiver IC 106 can include additional and/or different functional blocks or could be implemented using other receiver configurations, as desired. For example, the receiver IC 106 could include a mixer configured to mix the incoming multi-carrier analog signals 104 to a lower frequency range prior to digitization by the ADC circuitry 108. It is also noted that the ADC circuitry 108 can be configured, if desired, to generate real (I) and imaginary (Q) components for each digital sample. Further, as indicated above, the IC 106 could be implemented as a transceiver and thereby include a transmitter and related operational blocks in addition to receiver related operational blocks. Other variations could also be implemented, if desired.

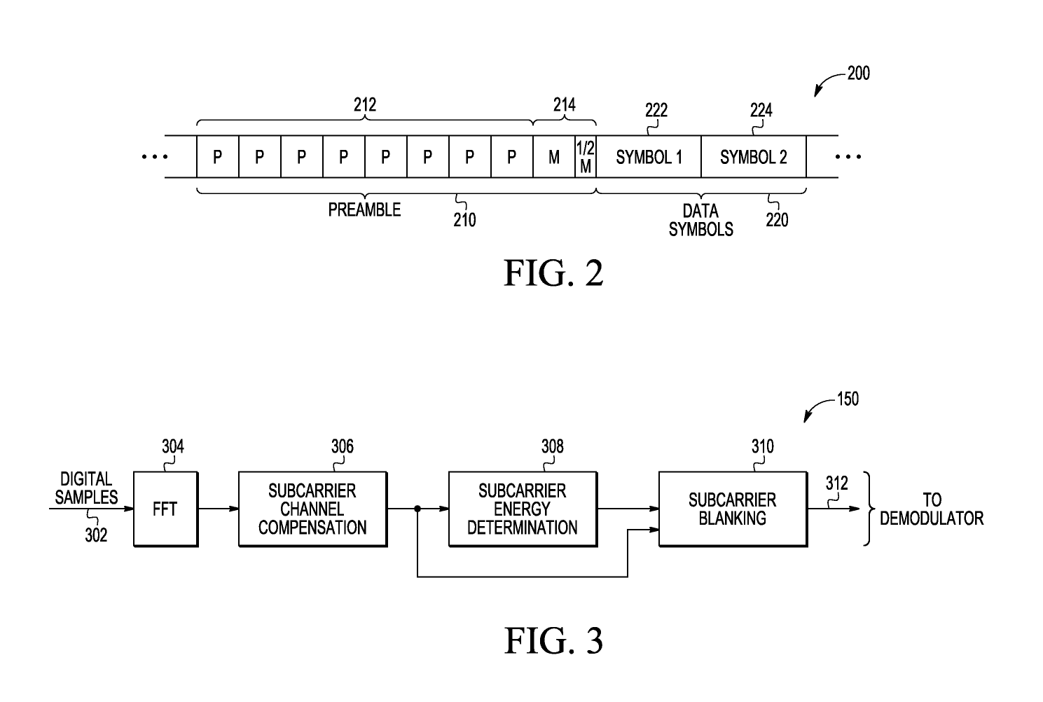

FIG. 2 is a signal diagram of an example embodiment 200 for a multi-carrier signal as utilized in PLC systems according to the G3-PLC standard. The transmitted signals include reference symbols within preamble 210 that are placed at the beginning of a transmission and data symbols 220 that provide the data payload for the transmission. The data symbols 220 include one or more symbols representing payload data, such as a first symbol (SYMBOL1) 222 and second symbol (SYMBOL2) 224. The preamble 210 include eight SYNCP reference symbols (P) 212 and one-and-a-half SYMCM reference symbols (M) 214 (e.g., one M reference symbol plus a ½ M reference symbol) for a total preamble length of 9½ symbols. The SYNCP symbols are identical and include a reference data sequence that can be used for symbol synchronization in G3-PLC receivers. The SYNCM symbol is the inverse of the SYNCP symbol and can be used for determination of the frame boundary in G3-PLC receivers. It is noted that header symbols within the preamble 210 can be part of the transmission that includes the data symbols 220 or can be transmitted separately. In addition, the preamble 210 can be present before or after the data symbols 220. It is further noted that a variety of reference symbols could be utilized and that reference symbols are typically designed to have good auto-correlation and cross-correlation properties.

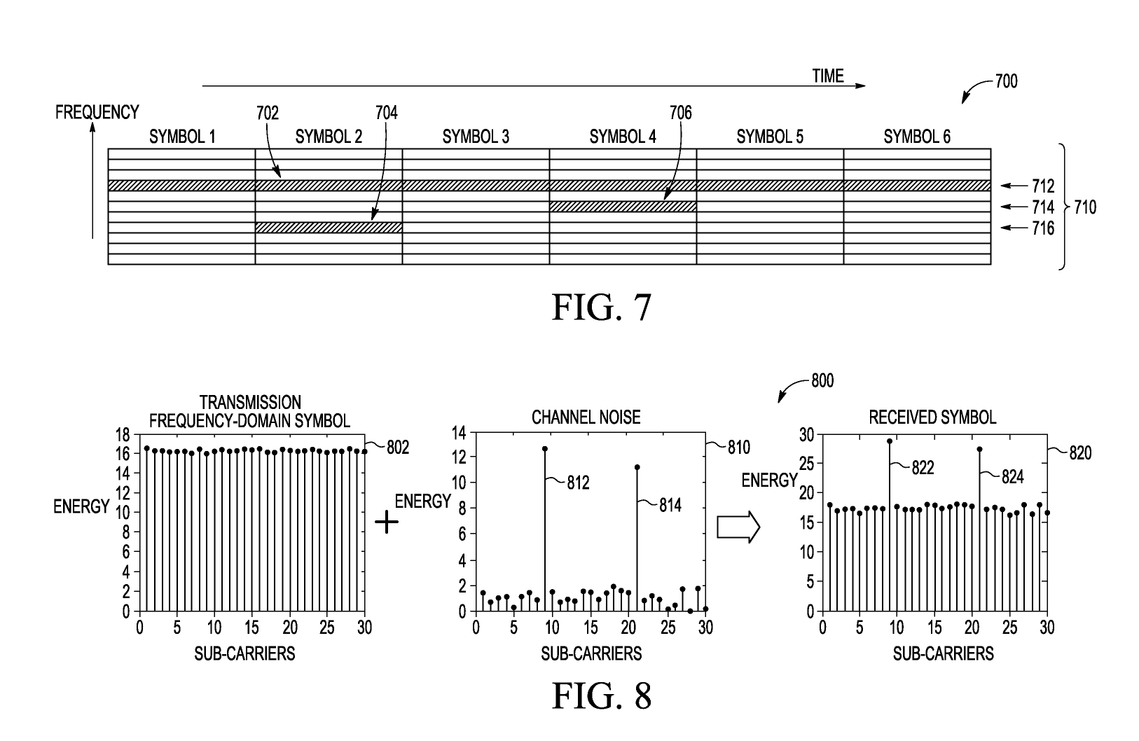

As described herein, a large channel noise on a subcarrier can destroy that subcarrier within received symbols affected by the noise event, thereby leading to false demodulated data within the receiver. FIGS. 7 and 8 provide examples of corrupted subcarriers and processing of corrupted subcarriers without carrier blanking

FIG. 7 is an example embodiment 700 for a representative diagram of tone interferers and impulse noise degrading subcarriers within multi-carrier symbols. In particular, for the embodiment 700 depicted, a number of symbols (SYMBOL1, SYMBOL2, SYMBOL3, SYMBOL4, SYMBOL5, SYMBOL6) are shown as being sequentially received in time. Each symbol includes frequency components 710, which are depicted as eleven frequency components for each symbol. Hashed area 702 represents a persistent tone that is interfering with the eighth frequency component 712 in each of the sequentially received symbols. Hashed area 704 represents impulse noise that interfered with the fourth frequency component in SYMBOL2. Hashed area 706 represents impulse noise that interfered with the sixth frequency component in SYMBOL4. Such tone and impulse noise can lead to false demodulated data within the receiver.

FIG. 8 is an example embodiment 800 for representative subcarrier diagrams for channel noise degrading carriers within a received symbol. Subcarrier diagram 802 represents one frequency-domain symbol from a transmission source that is being transmitted through a communication medium. For the embodiment depicted, the transmitted symbol shown in subcarrier diagram 802 includes thirty (30) subcarriers having about the same energy. Subcarrier diagram 810 represents channel noise for the communication channel used for the transmission. In particular, the noise energy level associated with each subcarrier of the transmitted symbol 802 is shown for channel noise 810. For the embodiment depicted, the noise energy 812 affecting the 9^{th} subcarrier and the noise energy 814 affecting the 21^{st} subcarrier are significantly higher than for the other subcarriers. Subcarrier diagram 820 represents the received symbol, which is a combination of the transmitted symbol 802 and the channel noise 810. For the embodiment depicted, the energy 822 in the 9^{th} subcarrier and the energy 824 in the 21^{st} subcarrier of the received symbol 820 are significantly higher than for the other subcarriers within the received symbol 820 due to increased channel noise at these subcarrier frequencies. As indicated above, such tone and impulse noise can lead to false demodulated data within the receiver. It is noted that the x-axis for the subcarrier diagrams represent subcarriers, and the y-axis represents energy using an arbitrary logarithmic scale.

In contrast to prior solutions, the embodiments described herein apply frequency-domain carrier blanking techniques to suppress corrupted subcarriers prior to demodulation, and these carrier blanking techniques can be applied in a dynamic fashion such that the techniques are applied independently to each OFDM symbol. As described herein, an FFT is applied to digital samples for each received symbol. The FFT outputs represent frequency component values for the subcarriers within the symbol. These frequency component values are then compensated, for example, using background channel energy estimates obtained from analyzing channel energy levels for transmissions with predetermined energy levels, such as preamble and/or pilots received from the communication medium. The compensated frequency component values are compared to a predefined threshold to identify corrupted subcarriers. For example, if energy associated with a frequency component exceeds a predefined energy threshold, the associated subcarrier can be deemed to be a corrupted subcarrier. Corrupted subcarriers within the symbol are then blanked. This blanking effectively removes the subcarrier from the symbol, for example, by providing zero magnitude result values for the blanked subcarrier to subsequent demodulator and decoder blocks. This blanking of corrupted subcarriers mitigates the effects of strong interference on the performance of ECC (error correction code) mechanisms. It is noted that the energy threshold values utilized for the energy comparison can be selected, for example, using an empirical analysis of channel noise within a particular communication medium being utilized. Other techniques could also be utilized, as desired, to select the energy threshold value. Further, it is assumed that there are X samples associated with each symbol where X depends upon the sample rate and the symbol time period (i.e., the transmit time period for each symbol) for the communication protocol being utilized. For example, with the G3-PLC standard, a sampling rate of 400 ksps (kilo samples per second) can be used for a symbol time period of 715 microseconds to generate 256 samples per symbol after removal of the 30 sample cyclic prefix.

FIG. 3 is a block diagram of an example embodiment for the frequency-domain carrier blanking block 150 for processing multi-carrier input signals. The input signals 302 can be digital samples associated with the received multi-carrier signals. If desired, these digital samples 302 can be filtered digital samples, for example, digital samples filtered by filtering block 122, as described above with respect to FIG. 1, although unfiltered digital samples could also be utilized. The digital samples 302 are provided to FFT block 304 that operates to transform the digital samples 302 for a received symbol (e.g., X samples per symbol) into N frequency components corresponding to the N subcarriers within the multi-carrier input signals. The frequency components are provided to subcarrier channel compensation block 306 that operates to compensate each frequency component with respect to estimated channel background energy. The compensated frequency components are then provided to subcarrier energy determination block 308 that operates to calculate the energy level associated with each subcarrier. The resulting subcarrier energy levels are then provided to subcarrier blanking block 310 that operates to identify corrupted subcarriers within the symbol and to blank each corrupted subcarrier. For example, a subcarrier can be deemed to be corrupted where the compensated energy level for the subcarrier exceeds a predefined energy threshold level. Further, the blanking can be applied dynamically on a symbol-by-symbol basis. The output frequency component values 312 from the subcarrier blanking block 310 are then furnished to the demodulation process to generate demodulated data. For example, the outputs 312 can then be processed further, as desired, by the demodulation block 126 and other functional blocks, such as the additional blocks shown in FIG. 1.

It noted that the channel compensation provided by block 306 can be performed using the following equation:

$${Y}_{i} = \frac{{X}_{i}}{{CH}_{i}} for i = 1 to N \qquad [ EQUATION 1 ]$$

For this EQUATION 1, the expression Yᵢ represents a per-carrier channel compensated value; the expression Xᵢ represents the per-carrier frequency component value; the expression CHᵢ represents an estimate of the background channel energy characteristic of each subcarrier; and N represents the number of subcarriers within the received symbols. The channel estimate for each subcarrier can be determined, for example, by analyzing energy levels for each subcarrier within the communication channel when receiving known signals, such as a preamble, pilots, and/or other signals with known relative transmitted energy levels. It is further noted that the compensation operation is performed separately for each of the N frequency components generated by the FFT block 304. Further, it is preferable that N frequency components are associated with each of the N subcarriers within received symbols, such that a different Yᵢ is generated for each subcarrier frequency component. Applying the channel estimate (CHᵢ) for each subcarrier to the complex FFT result values (X₁) in the compensation equation above effectively removes the average channel characteristic from these FFT result values.

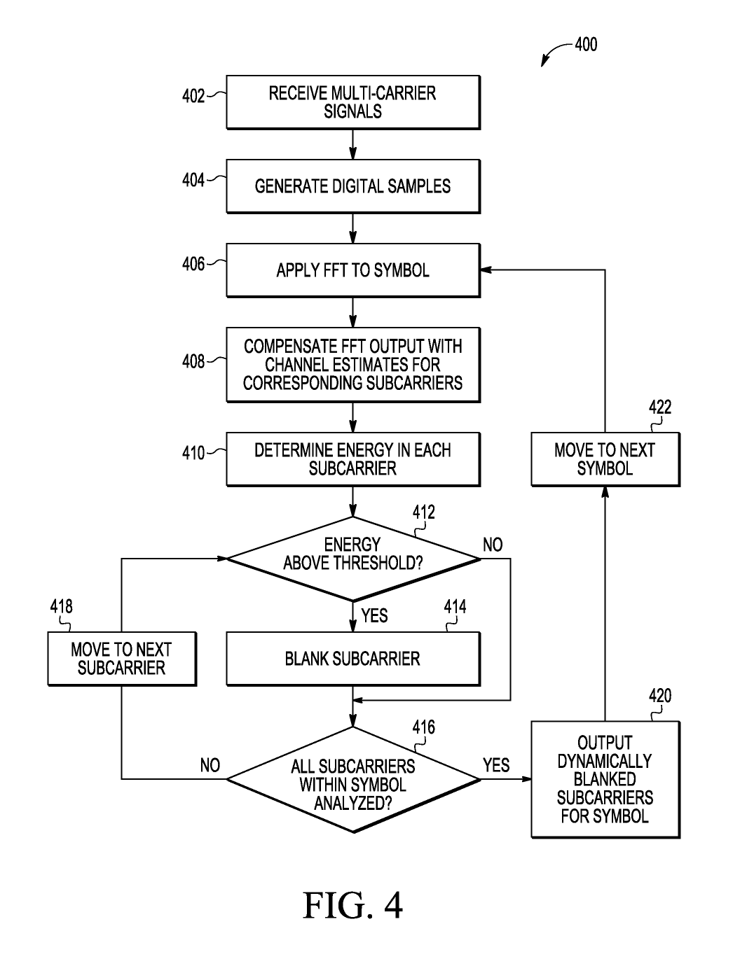

FIG. 4 is a process flow diagram of an example embodiment 400 for frequency-domain carrier blanking for multi-carrier input signals. In block 402, the input multi-carrier signals are received from the communication medium. In block 404, digital samples are generated. In block 406, an FFT is applied to the digital samples for each symbol (e.g., X samples per symbol) to transform the digital samples into frequency components associated with the subcarriers within the received symbols. As described above, the frequency components generated by the FFT can be complex values, including both real (I) and imaginary (Q) components. Next, in block 408, the frequency components output from the FFT are compensated to form compensated frequency components associated with the subcarriers. In particular, the frequency component for each subcarrier in the received symbol is compensated using a channel estimate for the subcarrier. The energy level for each compensated subcarrier is then determined in block 410. Next, in block 412, a comparison is made between the energy level of one subcarrier and a predefined energy threshold level to determine if the energy level exceeds the predefined energy threshold level. If “NO,” then flow passes to block 416. If “YES,” then flow passes to block 414 where the frequency component for that subcarrier is blanked. Flow then passes to block 416. In block 416, a determination is made whether all subcarriers within the symbol have been analyzed. If “NO,” then flow passes to block 418 where the next subcarrier is considered, and determination block 412 is again reached. If “YES,” then flow passes to block 420 where the blanked subcarriers are output for the symbol. Flow then passes to block 422 where the next symbol is considered, and block 406 is again reached. It is noted that process blocks 402 and 404 can be performed by ADC 108, process block 406 can be performed by block 304, process block 408 can be performed by block 306, process block 410 can be performed by block 308, and process blocks 412, 414, 416, and 418 can be performed by block 310. Further, the FD carrier blanking block 150 can perform process blocks 420 and 422 to apply the subcarrier blanking process to each received symbol. Variations could be implemented, as desired.

As described herein, frequency components for subcarriers within a received symbol are blanked when energy levels are detected for the subcarriers that indicate that they have been corrupted by noise events within the communication channel. Further, this blanking can be performed dynamically on a symbol-by-symbol basis. Advantageously, the frequency-domain carrier blanking described herein significantly improves error rate performance in multi-carrier receivers. Further, as indicated above, the energy threshold value for carrier blanking can be selected, for example, using an empirical analysis of channel noise within a particular communication medium and/or can be selected using other techniques. It is noted that if the energy threshold level is selected to be too low, then uncorrupted carriers may be blanked. Conversely, if the energy threshold level is selected to be too high, then corrupted carriers may not be blanked. As such, the energy threshold level can be adjusted to achieve a desired trade-off between allowing corrupted carriers to pass and blanking uncorrupted carriers. Again, this energy threshold level can be set through an empirical analysis of the communication medium, such as through testing applied to the receive systems, and/or using some other desired technique.

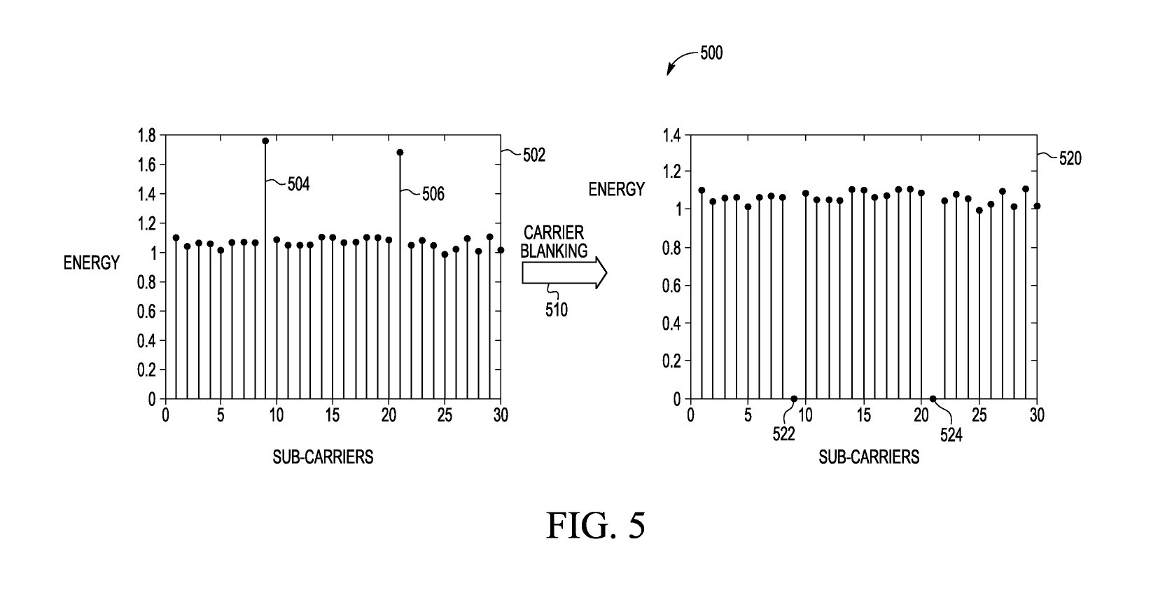

FIG. 5 is an example embodiment 500 for representative subcarrier diagrams for frequency-domain carrier blanking to reduce errors in demodulation of multi-carrier signals. Subcarrier diagram 502 represents channel-compensated energy values for subcarriers within a received symbol, such as would be determined by block 308 in FIG. 3. As depicted, the compensated energy values are provided for thirty (30) subcarriers, and the compensated energy 504 for the 9^{th} subcarrier and the compensated energy 506 for the 21^{st} subcarrier are significantly higher than that of the other subcarriers. As described herein, carrier blanking 510 is applied to identify corrupted subcarriers and to blank any subcarrier determined to be corrupted. For example, if the energy level for a subcarrier exceeds a predefined threshold level, the subcarrier can be deemed to be corrupted and can then be blanked. Looking to embodiment 500, it is seen that a threshold level could be selected and applied such that energy levels 504 and 506 would exceed the threshold level while the other energy levels would not. As such, carrier blanking 510 would operate to blank the 9^{th} and 21^{st} subcarriers, both of which would be deemed corrupted. Subcarrier diagram 520 represents the resulting compensated energy values with energy 522 and energy 524 being blanked for the 9^{th} and 21^{st} subcarrier. It is noted that the x-axis for the subcarrier diagrams represents subcarriers, and the y-axis represents channel-compensated energy using a logarithmic scale.

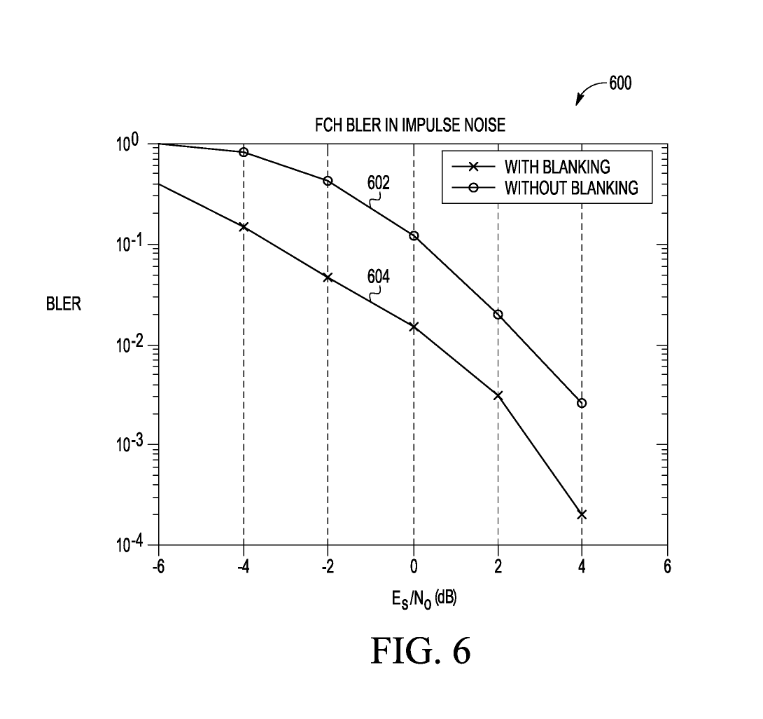

FIG. 6 is an example embodiment 600 for a representative diagram comparing results for using and not using frequency-domain carrier blanking in the presence of impulsive noise and/or tone interferers. In particular, for the embodiment 600 depicted, the frame channel (FCH) block error rate (BLER) is shown in the presence of impulse noise. The x-axis represents a logarithmic scale for BLER (block error rate), which is a measure of the ratio of the number of blocks with bit errors to a total number of blocks over a communication session. The y-axis represents energy of the received symbol (E_{S}) with respect to the ambient noise power (N₀) in the communication channel in decibels (dB). Line 602 represents the BLER where frequency-domain carrier blanking is applied dynamically on a symbol-by-symbol basis. Line 604 represents the BLER without using this dynamic frequency-domain carrier blanking. As seen in embodiment 600, the BLER is significantly reduced when frequency-domain carrier blanking is used. This reduction in BLER leads to fewer bit errors in the resulting decoded data, thereby improving performance of the receiver system.

As described herein, a variety of embodiments can be implemented and different features and variations can be implemented, as desired.

One embodiment is a method for processing multi-carrier signals including receiving multi-carrier input signals from a communication medium, digitizing the multi-carrier input signals to generate digital samples, generating frequency components for the digital samples with the frequency components being associated with subcarriers within a symbol within the input signals, compensating the frequency components with background channel energy estimates to generate compensated frequency components associated with the subcarriers within the symbol, determining an energy level for each of the compensated frequency components, identifying corrupted subcarriers based upon a comparison of the energy level for each subcarrier to a threshold energy level, blanking the frequency component for each subcarrier identified to be corrupted, and outputting the frequency components for the symbol with the frequency component for each corrupted subcarrier being blanked and with the frequency component for each non-corrupted subcarrier not being blanked.

In other embodiments, the generating step includes applying a Fast Fourier Transform (FFT) to the digital samples to generate the frequency components. In further embodiments, the generating, normalizing, determining, identifying, blanking, and outputting steps are repeated to provide carrier blanking for received symbols on a symbol-by-symbol basis. In addition, the method can further include demodulating the frequency components for the symbols to generate demodulated data and applying error correction to the demodulated data. The compensating step can include compensating each frequency component using a background channel energy estimate for the subcarrier associated with that frequency component. The identifying step can include identifying a subcarrier as corrupted if the energy level for the subcarrier exceeds the threshold energy level. Still further, the threshold energy level can be based upon an analysis of channel noise within the communication medium. In still further embodiments, the symbols can be OFDM (orthogonal frequency division multiplexed) symbols. In addition, the OFDM symbols can be formatted according to the G3-PLC standard for power line communication (PLC) systems. For further embodiments, the method can include transmitting multi-carrier signals to the communication medium.

Another embodiment is a system for receiving multi-carrier signals including analog to digital converter (ADC) circuitry configured to receive input signals from a communication medium and to output digital samples, a Fast Fourier Transform (FFT) block configured to receive the digital samples and to generate frequency components associated with subcarriers within a symbol within the input signals, a compensation block configured to compensate the frequency components with background channel energy estimates to generate compensated frequency components associated with the subcarriers within the symbol, an energy detector block configured to determine an energy level for each of the compensated frequency components, and a subcarrier blanking block. Further, the subcarrier blanking block can be configured to identify corrupted subcarriers based upon a comparison of the energy level for each subcarrier to a threshold energy level, to blank the frequency component for each subcarrier identified to be corrupted, and to output the frequency components for the symbol with the frequency component for each corrupted subcarrier being blanked and with the frequency component for each non-corrupted subcarrier not being blanked.

In other embodiments, the subcarrier blanking block is further configured to provide carrier blanking for received symbols on a symbol-by-symbol basis. In addition, the system can further include a digital signal processor (DSP) in turn including the FFT block, the compensation block, the energy detector block, and the subcarrier blanking block. Still further, the system can include a demodulator configured to receive the frequency components from the subcarrier blanker and to generate demodulated data and can further include an error correction block configured to apply error correction to the demodulated data. In other embodiments, the compensation block can be configured to compensate each frequency component using a background channel energy estimate for the subcarrier associated with that frequency component. Still further, the subcarrier blanking block can be configured to identify a subcarrier as corrupted if the energy level for the subcarrier exceeds the threshold energy level. In addition, the threshold energy level can be based upon an analysis of channel noise within the communication medium. Still further, the communication medium can be a power line communication medium. Also, the symbols can be OFDM (orthogonal frequency division multiplexed) symbols. Further, the OFDM symbols can be formatted according to the G3-PLC standard for power line communication (PLC) systems.

Unless stated otherwise, terms such as “first” and “second” are used to arbitrarily distinguish between the elements such terms describe. Thus, these terms are not necessarily intended to indicate temporal or other prioritization of such elements.

Further modifications and alternative embodiments of the described systems and methods will be apparent to those skilled in the art in view of this description. It will be recognized, therefore, that the described systems and methods are not limited by these example arrangements. It is to be understood that the forms of the systems and methods herein shown and described are to be taken as example embodiments. Various changes may be made in the implementations. Thus, although the invention is described herein with reference to specific embodiments, various modifications and changes can be made without departing from the scope of the present invention. Accordingly, the specification and figures are to be regarded in an illustrative rather than a restrictive sense, and such modifications are intended to be included within the scope of the present invention. Further, any benefits, advantages, or solutions to problems that are described herein with regard to specific embodiments are not intended to be construed as a critical, required, or essential feature or element of any or all the claims.

What is claimed is:

1. A method for processing multi-carrier signals, comprising:
receiving multi-carrier input signals from a communication medium;
digitizing the multi-carrier input signals to generate digital samples;
generating frequency components for the digital samples, the frequency components being associated with subcarriers within a symbol within the input signals;
compensating the frequency components with background channel energy estimates to generate compensated frequency components associated with the subcarriers within the symbol;
determining an energy level for each of the compensated frequency components;
identifying corrupted subcarriers based upon a comparison of the energy level for each subcarrier to a threshold energy level;
blanking the frequency component for each subcarrier identified to be corrupted; and
outputting the frequency components for the symbol with the frequency component for each corrupted subcarrier being blanked and with the frequency component for each non-corrupted subcarrier not being blanked.

2. The method of claim 1, wherein the generating step comprises applying a Fast Fourier Transform (FFT) to the digital samples to generate the frequency components.

3. The method of claim 1, wherein the generating, normalizing, determining, identifying, blanking, and outputting steps are repeated to provide carrier blanking for received symbols on a symbol-by-symbol basis.

4. The method of claim 1, further comprising demodulating the frequency components for the symbols to generate demodulated data and applying error correction to the demodulated data.

5. The method of claim 1, wherein the compensating step comprises compensating each frequency component using a background channel energy estimate for the subcarrier associated with that frequency component.

6. The method of claim 1, wherein the identifying step comprises identifying a subcarrier as corrupted if the energy level for the subcarrier exceeds the threshold energy level.

7. The method of claim 6, wherein the threshold energy level is based upon an analysis of channel noise within the communication medium.

8. The method of claim 1, wherein the symbols comprise OFDM (orthogonal frequency division multiplexed) symbols.

9. The method of claim 8, wherein the OFDM symbols are formatted according to the G3-PLC standard for power line communication (PLC) systems.

10. The method of claim 1, further comprising transmitting multi-carrier signals to the communication medium.

11. A system for receiving multi-carrier signals, comprising:
analog to digital converter (ADC) circuitry configured to receive input signals from a communication medium and to output digital samples;
a Fast Fourier Transform (FFT) block configured to receive the digital samples and to generate frequency components associated with subcarriers within a symbol within the input signals;
a compensation block configured to compensate the frequency components with background channel energy estimates to generate compensated frequency components associated with the subcarriers within the symbol;
an energy detector block configured to determine an energy level for each of the compensated frequency components; and
a subcarrier blanking block configured to identify corrupted subcarriers based upon a comparison of the energy level for each subcarrier to a threshold energy level, to blank the frequency component for each subcarrier identified to be corrupted, and to output the frequency components for the symbol with the frequency component for each corrupted subcarrier being blanked and with the frequency component for each non-corrupted subcarrier not being blanked.

12. The system of claim 11, wherein the subcarrier blanking block is further configured to provide carrier blanking for received symbols on a symbol-by-symbol basis.

13. The system of claim 11, further comprising a digital signal processor (DSP) including the FFT block, the compensation block, the energy detector block, and the subcarrier blanking block.

14. The system of claim 11, further comprising a demodulator configured to receive the frequency components from the subcarrier blanker and to generate demodulated data and further comprising an error correction block configured to apply error correction to the demodulated data.

15. The system of claim 11, wherein the compensation block is configured to compensate each frequency component using a background channel energy estimate for the subcarrier associated with that frequency component.

16. The system of claim 11, wherein the subcarrier blanking block is configured to identify a subcarrier as corrupted if the energy level for the subcarrier exceeds the threshold energy level.

17. The system of claim 16, wherein the threshold energy level is based upon an analysis of channel noise within the communication medium.

18. The system of claim 12, wherein the communication medium comprises a power line communication medium.

19. The system of claim 18, wherein the symbols comprise OFDM (orthogonal frequency division multiplexed) symbols.

20. The system of claim 19, wherein the OFDM symbols are formatted according to the G3-PLC standard for power line communication (PLC) systems.
